(19) United States
(12) Patent Application Publication
(10) Pub. No.: US 2010/0243593 A1
(43) Pub. Date: Sep. 30, 2010

(54) METHOD AND APPARATUS FOR CRANE TOPPLE/COLLISION PREVENTION

(76) Inventors: Henry King, Moraga, CA (US); Toru Takehara, Foster City, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/748,343

(22) Filed: Mar. 26, 2010

Related U.S. Application Data
(60) Provisional application No. 61/163,847, filed on Mar. 26, 2009.

(51) Int. Cl. B66C 15/06; G06F 19/00; B66C 1/10; B66C 15/00; B66C 19/00

(52) U.S. Cl. 212/276; 701/50

(57) ABSTRACT

Methods and apparatus are disclosed for a crane safety device configured to operate a processor estimating a trajectory for the crane, determining a potentially dangerous event in response to a yard estimate and the trajectory, and sending alert messages in response to the potentially dangerous event. The processor may further generate the yard estimate. The embodiments may include means for implementing these operations, sensors of the yard estimate to generate the yard estimate, computer readable devices and/or a server containing a program system to instruct a computer to at least partly operate the processor and/or an installation package to create the program system.

### CROSS REFERENCE TO RELATED APPLICATIONS

This invention claims priority to Provisional U.S. Patent Application No. 61/163,847 filed Mar. 26, 2009 and incorporated herein by reference.

### TECHNICAL FIELD

This invention relates to avoiding dangerous events for cranes.

### BACKGROUND OF THE INVENTION

Crane safety is a primary concern at any site where they are used. It is quite easy for a crane operator to make a mistake and cause the crane to strike an object or structure creating a dangerous situation for humans, the equipment and the container that may be involved. And equipment failures such as cables breaking can cause large objects to fall or be flung, either of which is dangerous. Methods and mechanisms are needed for automating the avoidance of potentially dangerous events to reduce the number of dangerous events that actually occur.

### SUMMARY OF THE INVENTION

Embodiments of the invention include a crane safety device that estimates movement associated with a crane and its spreader, determines when there is the potential for a dangerous event based upon the movement and sends alerts to at least the immediate vicinity of the crane, known as its yard, to avert the dangerous event.

Examples of the dangerous events that the crane safety device may help avert include the spreader colliding with a stack of containers, the spreader holding container that collides with the container stack, a container toppling off of a chassis, a container toppling off of a container stack, a spreader failing to disengage causing a loaded chassis and possibly its truck to be lifted up, as well as failures involving cables, hoists, brakes and/or hydraulic systems.

As used herein a yard estimate will refer to an estimate of any condition in the immediate vicinity of the crane that can lead to one or more of the dangerous events. Examples of such conditions include a container height, a truck position, a chassis position, a ship berth position, and/or a rail car position.

Movement by the crane and/or its spreader will generally be referred to as trajectories that may include any combination of a container trajectory, a spreader trajectory, and/or a crane trajectory, any of which may include a location and a velocity.

The alerts will generally be referred to as alert messages such as a management system alert, an audio alarm message, a visual alarm message and/or an equipment shutdown message.

The crane safety device may operate a processor estimating the trajectory, determining a potentially dangerous event in response to the yard estimate and the trajectory, and sending at least one of the alert messages in response to the potentially dangerous event. The processor may generate at least part of the yard estimate.

A machine state related to the crane may at least partly determine a trajectory and may include the spreader state. The crane may be a gantry crane that may include, but is not limited to, a rubber tire gantry, a rail mounted gantry crane and/or a quay crane, with the machine state perhaps further including a hoist position, a hoist velocity, and/or a trolley position. The crane may be a front end loader, a side loader, a side picker, a top loader and/or a top picker, with the machine state perhaps further including a hydraulic extension estimate.

The embodiments may include means for implementing these operations, sensors of the yard state to generate the yard estimate, computer readable devices and/or a server containing a program system to instruct a computer to at least partly operate the processor and/or an installation package to create the program system.

### BRIEF DESCRIPTION OF THE DRAWINGS

FIGS. 1A to 1D show a crane either experiencing or about to experience a variety of dangerous situations. A crane safety device averts any or all of these through the operation of a processor estimating a trajectory, determining the potentially dangerous event in response to a yard estimate and the trajectory, and sending alert messages in response to the potentially dangerous event.

FIG. 2 shows the processor may include at least one of an inferential engine, a finite state machine, a computer and/or a computer accessible memory configured to be accessed by the computer to retrieve a program system to instruct the computer to operate the processor in accord with the crane safety device disclosed herein. This Figure also shows a computer readable memory and/or a server configured to communicate the program system and/or the installation package to the processor to instruct the computer to install the program system.

FIG. 3 shows the yard estimate may include at least one container height, a chassis position, a truck position, a ship berth position, and/or a rail car position.

FIG. 4 shows the trajectory may include an estimate of any combination of a container trajectory, a spreader trajectory, and/or a crane trajectory.

FIG. 5 shows some examples of the potentially dangerous event.

FIG. 6 shows some details of the alert message.

FIGS. 7 to 8F outline some of the cranes to which some embodiments of the crane safety device may be configured to avert dangerous situations.

FIGS. 9 to 13 show flowcharts of example operations of the methods.

FIG. 14 shows a simplified block diagram of the processor configured to respond to the machine state based upon an interaction over a first communicative coupling with at least one machine state sensor and to respond to the yard estimate based upon a second interaction over a second communicative coupling to at least one yard state sensor. The alert message may be sent using a wireless transceiver as a wireless communication to a management system to create a system alert message.

FIG. 15 shows some details of some yard state sensors.

FIG. 16 shows that any of the yard state sensors and/or the machine state sensors may include at least one of a member of the sensor type group consisting of a light emitting sensor, an ultrasonic emitting sensor and/or a proximity sensor that may be used in a fixed beam position or a sweeping beam path for light or sound emission.

FIGS. 17A to 17C shows some examples of the first communicative coupling and/or the second communicative coupling using a Programmable Logic Controller (PLC), a wireline interface and/or a relay interface.

FIG. 18 shows some examples of the machine state sensor.

And FIG. 19 shows some examples of crane trajectory sensors.

### DETAILED DESCRIPTION

This invention relates to avoiding dangerous events for cranes. Embodiments of the invention include a crane safety device that estimates movement associated with a crane and its spreader, determines when there is the potential for a dangerous event based upon the movement and sends alerts to at least the immediate vicinity of the crane, known as its yard, to avert the dangerous event.

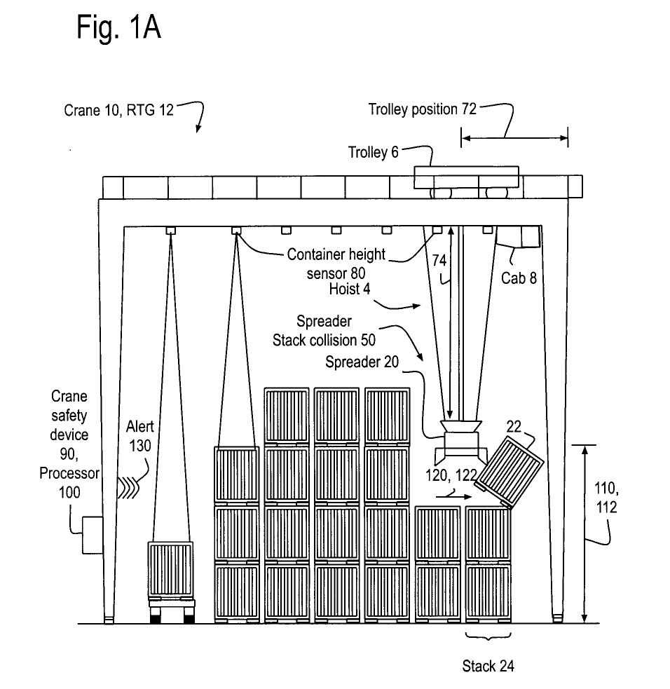

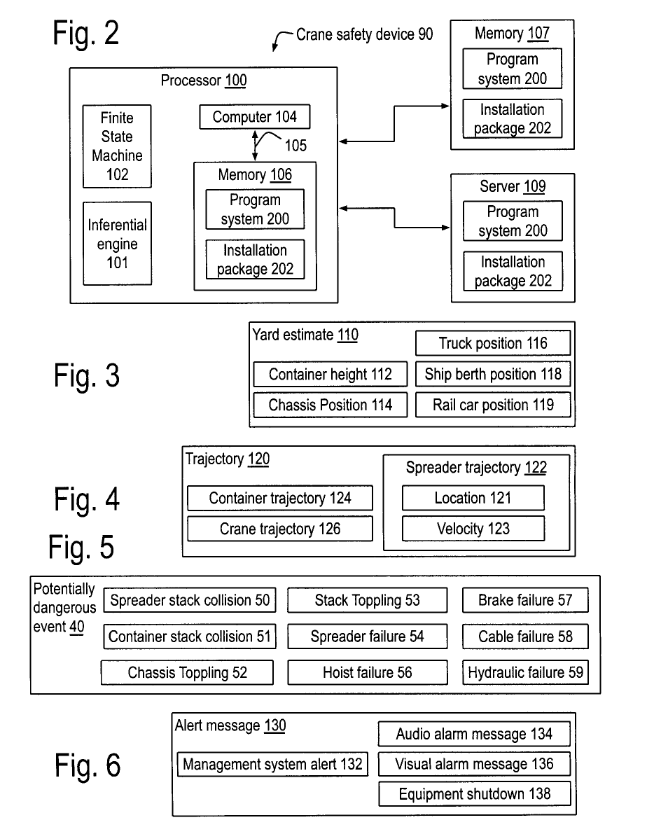

Examples of the dangerous events that the crane safety device 90 may help avert include the spreader 20 colliding 50 with a stack 24 of containers as shown in FIG. 1A, the spreader holding a container 22 that collides 51 with the container stack as shown in FIG. 5, a container toppling 52 off of a chassis 3 as shown in FIG. 1B, a container toppling 53 off of a container stack as shown in FIG. 1C, a spreader failing 54 to disengage causing a loaded chassis and possibly its truck 2 to be lifted up, as well as failures involving cables, hoists, brakes and/or hydraulic systems which are further shown and discussed in FIG. 5.

The yard estimate 110 refers to an estimate of any condition in the immediate vicinity of the crane 10 that can lead to one or more of the dangerous events 40.

Movement by the crane 10 and/or its spreader 20 will generally be referred to as trajectories 120 that may include any combination of a container trajectory 124, a spreader trajectory 122, and/or a crane trajectory 126, any of which may include a location 121 and a velocity 123.

The alerts will generally be referred to as alert messages 130 such as a management system alert 132, an audio alarm message 134, a visual alarm message 136 and/or an equipment shutdown message 138.

The crane safety device 90 may be configured to operate a processor 100 estimating the trajectory 120, determining a potentially dangerous event 40 in response to the yard estimate 110 and the trajectory, and sending at least one of the alert messages 130 in response to the potentially dangerous event. The processor may generate at least part of the yard estimate.

A machine state 70 related to the crane 10 may at least partly determine a trajectory 120 and may include the spreader state 78.

The crane may be a gantry crane that may include, but is not limited to, a rubber tire gantry and/or a quay crane, with the machine state perhaps further including a hoist position, a hoist velocity, and/or a trolley position.

FIGS. 1A to 1D show a crane 10, in particular a Rubber Tire Gantry (RTG) crane 12 either experiencing or about to experience a variety of dangerous situations. A crane safety device 90 averts any or all of these through the operation of a processor 100 estimating a trajectory 120, determining the potentially dangerous event in response to a yard estimate and the trajectory, and sending alert messages 130 in response to the potentially dangerous event. The alert messages 130 may be sent not only around the crane 10 but also to the cab 8 where an operator may be seated and possibly also to a management system that will be discussed later.

FIG. 1A shows the crane 10 experiencing the stack collision 50 resulting from its spreader 20 colliding with a container 22 of the stack 24. The yard estimate 110 may include a container height estimate 112 of the stack 24. The trajectory 120 may include a spreader trajectory 122 for the crane. A container height sensor 80 may be operated as shown by the cone on the left to create the container height estimate 112, which may report in units of feet, inches, centimeters or a number of standardized container units. One or more machine states such as the position of the trolley 6, referred to as the trolley position 72 and/or the position of the hoist 4, referred to as the hoist position 74 and possibly the hoist velocity, which is not shown, may be used to estimate the spreader trajectory 122. Note that in some embodiments, the container height sensor may be coupled to the cab 8 to provide a profile of the container heights near the cab, which may be used in some situations as an alternative to placing these sensors over or near each container stack and/or chassis location.

FIG. 1B shows the crane 10 about to experience the toppling collision 52 from its spreader 20 about to place the container 22 incorrectly on a chassis 4 that will lead the container to topple. The yard estimate 110 may include a chassis position estimate 114 of the chassis 4. The trajectory 120 may include a container trajectory 122 for the container. Machine states such as the trolley position 72 and/or the hoist position 74 and/or the hoist velocity 76, may be used to estimate the container trajectory 124.

FIG. 1C shows the crane 10 about to experience a second toppling collision 52 from its spreader 20 about to place the container 22 the stack 24 that will lead the container to topple. The trajectory 120 may include a container trajectory 122 for the container. Machine states such as the trolley position 72 and/or the hoist position 74 and/or the hoist velocity 76, may be used to estimate the container trajectory 124.

FIG. 1D shows the crane 10 experiencing a spreader failure 54 where the spreader 20 fails to disengage from the container 22 after it is locked onto a chassis 4 that may lead to the chassis the container and probably a truck 2 with a driver rising off the loading platform 5. This may endanger the driver and also possibly damage the truck, chassis and container. The yard estimate 110 may include a chassis position estimate 114 of the chassis 4. The trajectory 120 may include a container trajectory 122 for the container. One or more machine states such as the trolley position 72 and/or the hoist position 74 and/or the hoist velocity 76 and/or the spreader state 78, may be used to estimate spreader trajectory 122 and/or the container trajectory 124.

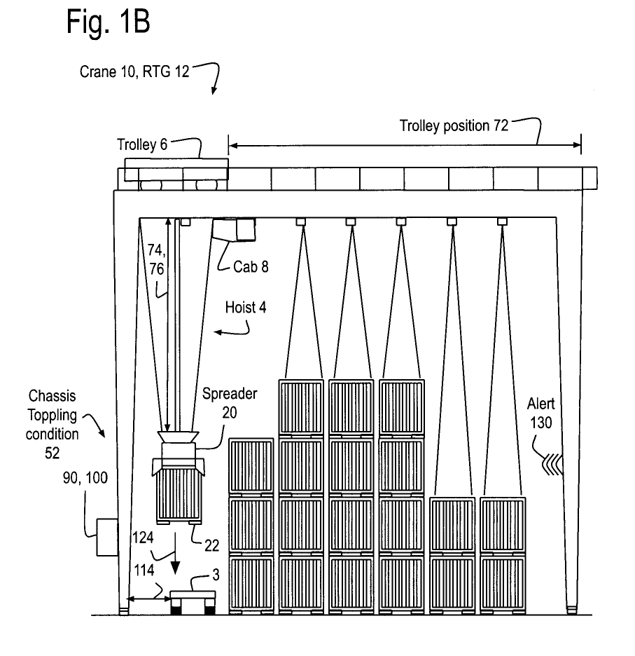

FIG. 2 shows a simplified block diagram of the processor 100 that may include at least one instance of an inferential engine 101, a finite state machine 102, a computer 104 and/or a computer accessible memory 106 configured to be accessed 105 by the computer to retrieve a program system 200 to instruct the computer to operate the processor in accord with the crane safety device disclosed herein. In some embodiments, the inferential engine may retrieve rule sets and/or fact patterns from a memory 106 to create inferences that may alter the fact patterns and/or rule sets and/or direct the computer and/or processor. This Figure also shows a computer readable memory 107 and/or a server 109 configured to communicate the program system 200 and/or the installation package 202 to the processor 100 to instruct the computer 104 to install the program system.

As used herein, the computer 104 may include at least one instruction processor and at least one data processor, with each data processor directed by at least one of the instruction processors and with at least one of the instruction processors at least partly implementing the operations of the processor 100 as disclosed herein through the discussion that follows regarding the program system 200. These operations may be at least partly illustrated through flowcharts showing program steps that may reside in the computer accessible memory 106, which may include volatile and/or non-volatile memory components.

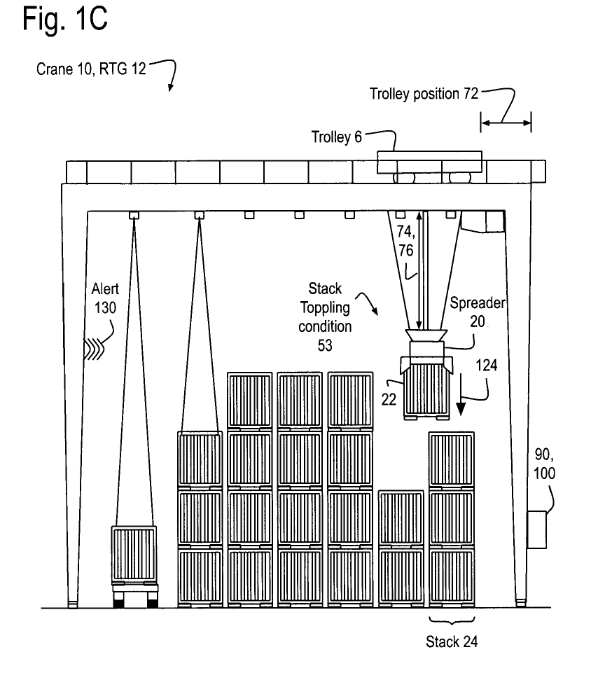

FIG. 3 shows that the yard estimate 110 may include an estimate of any combination of at least one container height 112, a chassis position 114, a truck position 116, a ship berth position 118, and/or a rail car position 119.

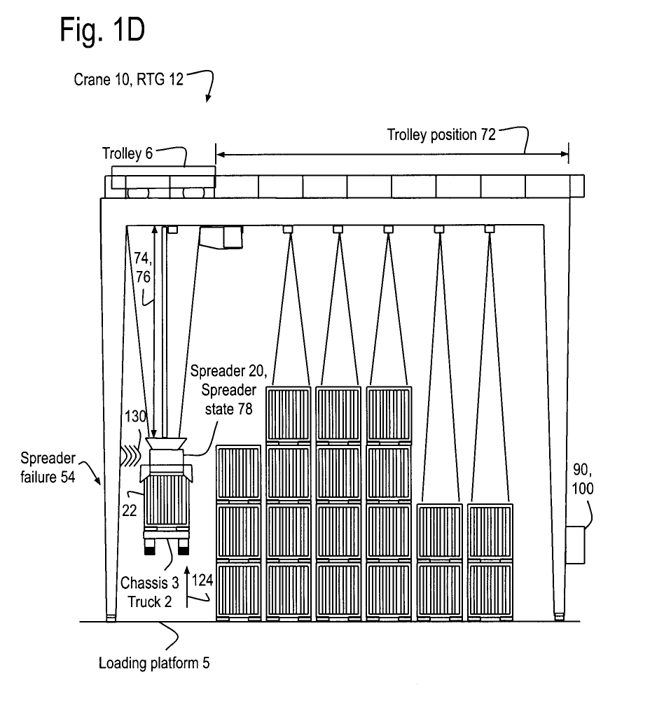

FIG. 4 shows that the trajectory 120 may include an estimate of any combination of a container trajectory 124, a spreader trajectory 122, and/or a crane trajectory 126, any of which may include a location 121 and/or a velocity 123. By way of example, crane trajectory for a quay crane moving 1 meter per minute might not require a velocity. Note that any of these trajectories may further include angular readings and/or angular velocities, particularly for cranes the rotate quickly.

FIG. 5 shows that the potentially dangerous event 40 may include any of the spreader stack collision 50, the container stack collision 51, the chassis toppling condition 52, the stack toppling condition 53, the spreader failure 54, the hoist failure 56, the brake failure 57, the cable failure 58 and/or the hydraulic failure 59.

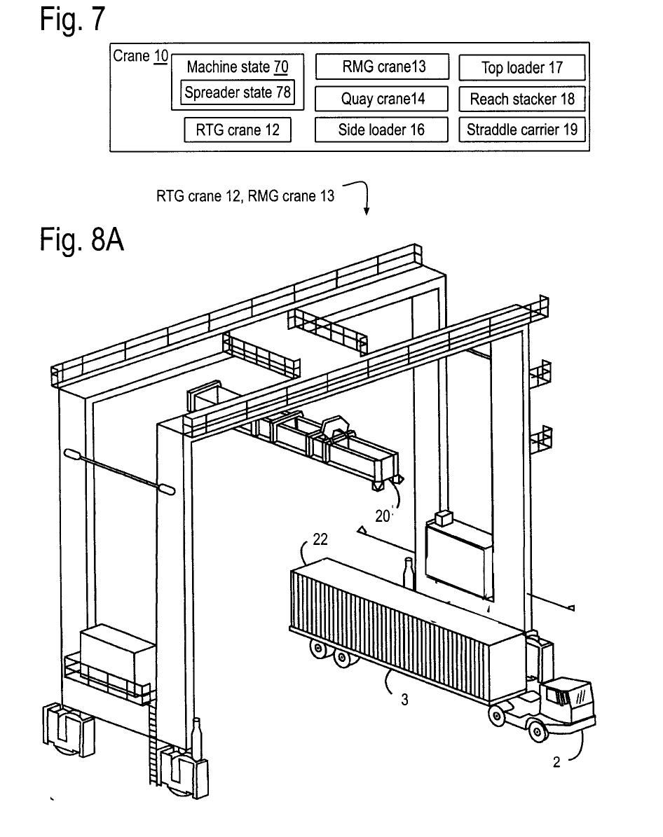

FIG. 6 shows the alert message 130 may include any of a management system alert 132, an audio alarm message 134, a visual alarm message 136 and/or an equipment shutdown message 138. Any of these messages may be embodied as an analog or digital signal, with the digital signal possibly being a wire state, a packet or frame compliant with a communications protocol such as TCP-IP or IEEE 802.11 or IEEE 802.17. The messages may further be encoded as XML in some embodiments.

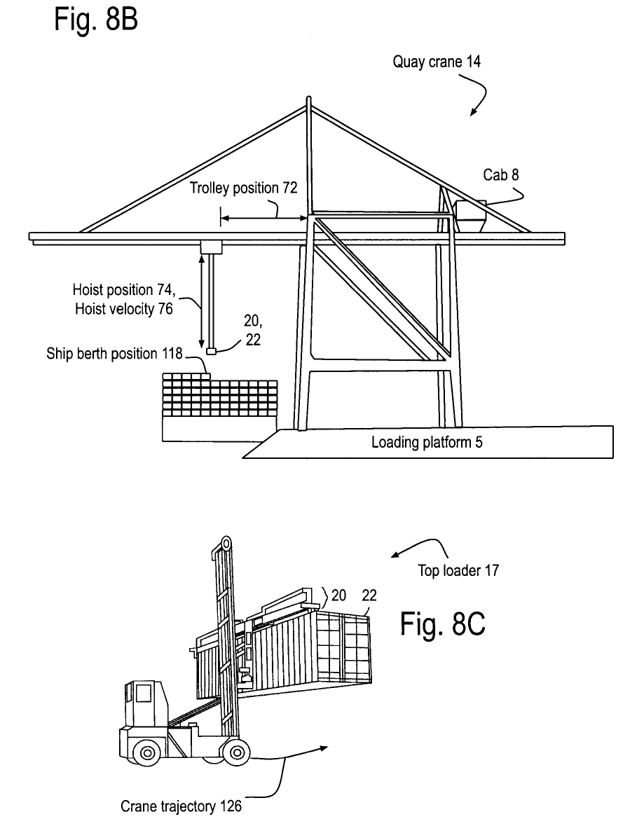

FIG. 7 outlines some of the cranes 10 to which some embodiments of the crane safety device 90 may be configured to avert dangerous situations as shown in FIGS. 1A to 1D. As used herein the crane may be any one of a Rail Mounted Gantry Crane (RMG) 13, a Rubber Tire Gantry (RTG) crane 12, a quay crane 14, a side loader 16, a top loader 17, a reach stacker 18 and a straddle carrier 19. All cranes as used herein have a spreader 20 by which to engage a container 22 for movement, releasing the container by disengaging the container. Note that for each of these cranes, the failure to disengage a container is a dangerous situation. For this reason, while the specific spreader mechanisms may differ between these cranes, they will be assumed to have a machine state 70 that includes the spreader state 78.

The gantry cranes may include the RTG crane 12, the Rail Mounted Gantry (RMG) crane 13 and the quay crane 14, which are shown in some more detail in FIGS. 8A and 8B. The RTG crane and the RMG crane look essentially the same, except that the first is mounted on tires and the second is mounted on rails. The machine state 70 of FIG. 7 may further include a hoist position 74, a hoist velocity 76, and/or a trolley position 72 shown in FIGS. 1A to 1D.

The crane 10 may be a side loader 16 as shown in FIG. 8D, a top loader 17 seen in FIG. 8C, a reach stacker 18 seen in FIG. 8E and/or a straddle carrier 19 seen in FIG. 8F. The machine state 70 for any of these cranes may further include a hydraulic extension 78 estimate as shown in FIG. 8E.

The Figures show several flowcharts of some example details of the program system 200 and/or the installation package 202 instructing the processor 100. These flowcharts show some example method embodiments, which may include arrows signifying a flow of control and/or state transitions as well as sometimes position data, supporting various example implementations. These may include a program operation, or program thread, executing upon the computer 104 or states of the finite state machine 102. Each of these program steps may at least partly support, implement and/or instruct the operation to be performed. The operation of starting as shown in the flowcharts refers to entering a subroutine or a macroinstruction sequence in the computer or of a possibly initial state or condition of the finite state machine. The operation of termination in a flowchart refers to completion of those operations, which may result in a subroutine return in the computer or possibly return the finite state machine to a previous condition or state. A rounded box with the word “Exit” in it denotes the operation of terminating a flowchart.

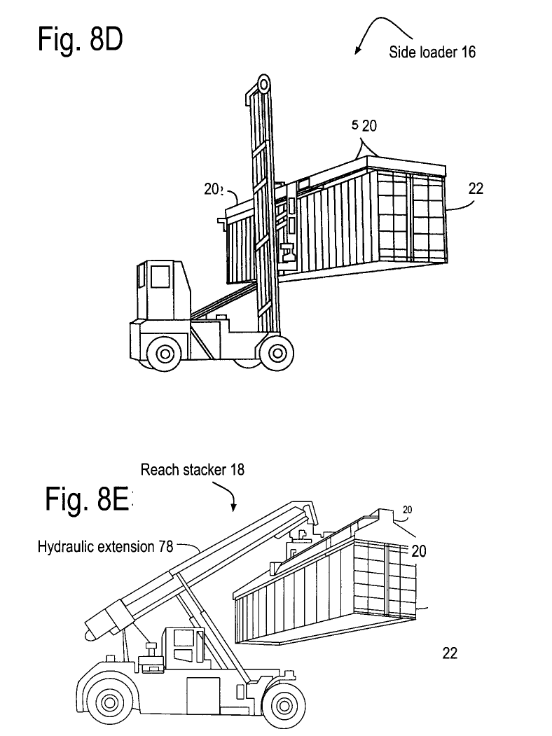

FIG. 9 shows a flowchart of some details of the installation package 202 including the program step 204 that supports instructions to create the program system 200 for use by the processor 100.

FIG. 10 shows a flowchart of the program system 200 supporting at least a method of operating the crane safety device 90 and/or the processor 100 that may include the following: Program step 210 supports estimating at least one trajectory 120 and the yard estimate 110 for the crane 10. Program step 212 supports determining potentially dangerous events 40 in response to the trajectory. And program step 214 supports sending at least one alert message 130 in response to the potentially dangerous event.

FIG. 11 shows a flowchart of the program system 200 and the method of operation that may further include program step 215 that supports generating the yard estimate 110.

FIG. 12 shows a flowchart of the program system 200 and the method of operation that further including program step 216 which supports generating the yard estimate 110.

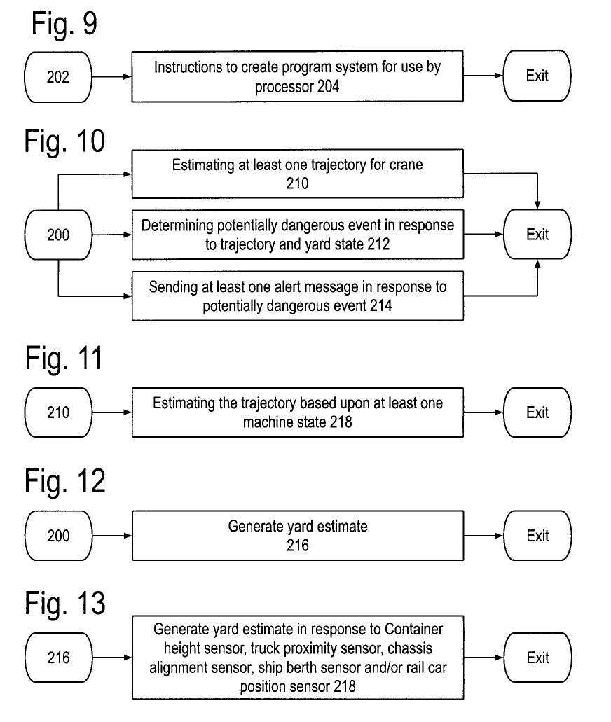

FIG. 13 shows a flowchart of some details of program step 216 supporting generating the yard estimate. Program step 218 further generates the yard estimate 110 in response to at least one container height sensor 80, a truck proximity sensor 156, a chassis alignment sensor 154, a ship berth sensor 158 and a rail car sensor 152, each of which are shown in FIG. 15.

The embodiments may include means for implementing the operations of the program steps seen in the flowcharts shown in these Figures as well as sensors to generate the yard estimate 110, including the container height sensors 80. The means may include at least one instance of a finite state machine 102, a computer 104 and/or the inferential engine 101 of FIG. 2.

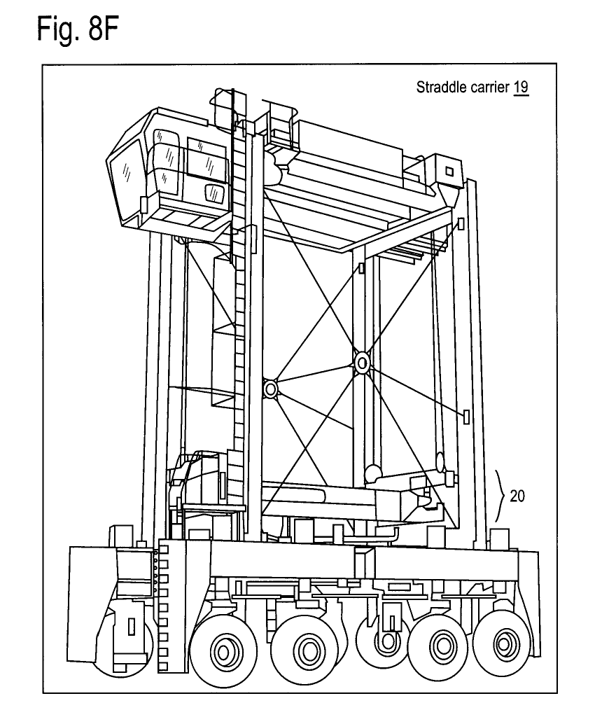

FIG. 14 shows a simplified block diagram of the processor 100 configured to respond to the machine state 70 based upon an interaction over a first communicative coupling 160 with at least one machine state sensor 170 that may generate a machine reading 168. The processor may be configured to respond to the yard estimate 110 based upon a second interaction over a second communicative coupling 160 to at least one yard state sensor 150 that may generate a yard state reading 140. The crane 10 may include at least one of the machine state sensor and/or at least one of the yard state sensor. Alternatively, some or all of these sensors may be mechanically, fluidic, or electrically coupled to the crane or crane equipment such as batteries and power supplies.

FIG. 14 also shows the alert message 130 may be sent using a wireless transceiver 290 as a wireless communication 164 to a management system 300 to create a system alert message 302. The management system may respond to the system alert message by logging the alert message, sending emergency personnel and/or altering maintenance schedules.

FIG. 15 shows some details of some example yard state sensors 150 that may be any one or more of the following: a container height sensor 80 for the container height 112, a chassis alignment sensor 154 for the chassis position 114, a truck proximity sensor 156 for the truck position 116, a ship berth sensor 158 for the ship berth position 118, and a rail car sensor 152 for the rail car position 119.

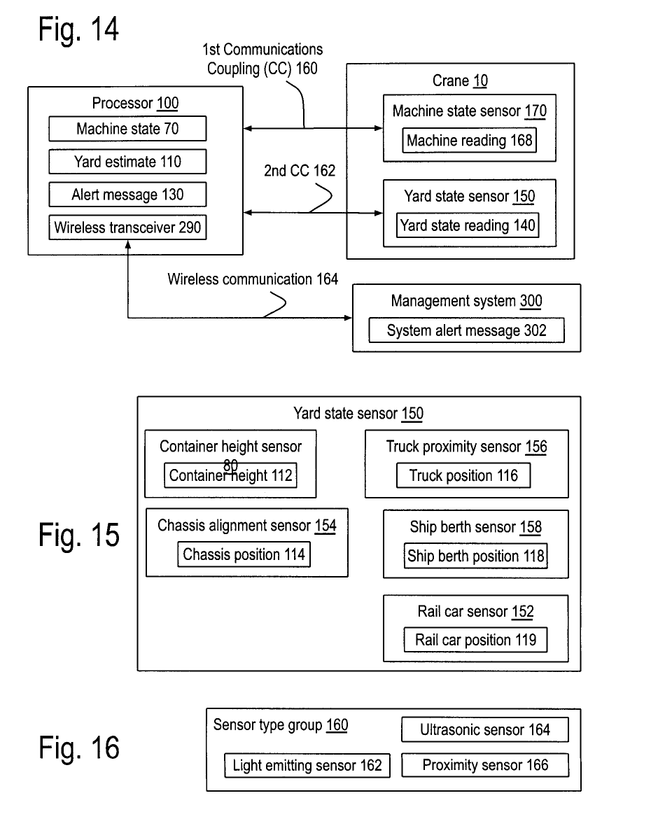

FIG. 16 shows that any of the yard state sensors 150 and/or the machine state sensors 170 may include at least one instance of a member of the sensor type group 160 that consists of a light emitting sensor 162, an ultrasonic emitting sensor 164 and/or a proximity sensor 166.

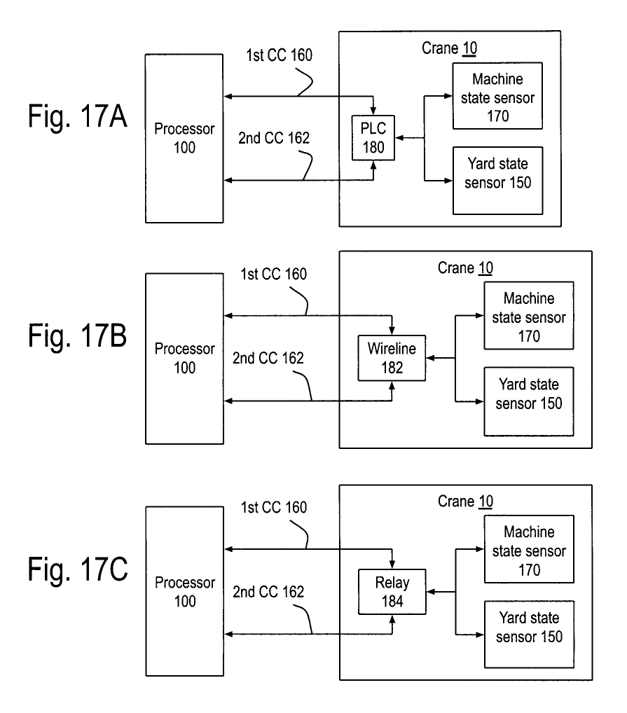

FIGS. 17A to 17C shows some examples of the first communicative coupling 160 and/or the second communicative coupling 162 to communicate with at least one machine state 170 and/or at least one yard state sensor 150. FIG. 17A uses a Programmable Logic Controller (PLC) 180. FIG. 17B uses a wireline interface 182. And FIG. 17C uses a relay interface 184. The wireline interface may for example be compatible with a form of Ethernet, RS-232, RS-422 and/or ICANN.

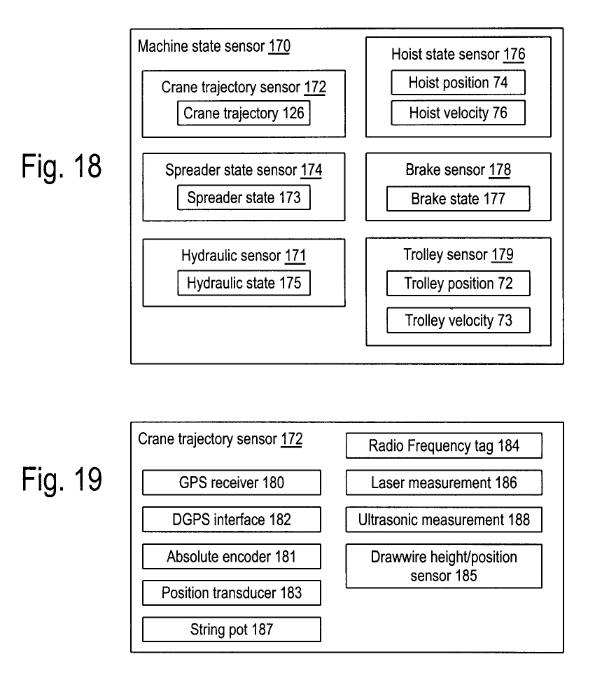

FIG. 18 shows some examples of the machine state sensor 170 that may include at least one instance of at least one of the following: a crane trajectory sensor 172 for the crane trajectory 126, a spreader state sensor 174 for the spreader state 173, a hoist state sensor 176 may use a reading of a gray scale coded wheel mounted in the hoist drum or on its axle to calculate the hoist position 74 and the hoist velocity 76, a brake sensor 158 for a braking state 157, a hydraulic sensor 151 for a hydraulic state 175 that may indicate the internal pressure of a hydraulic system in the crane 10, and a trolley sensor 159 that may read a gray scale coded wheel mounted in the trolley drum or on its axle to calculate the trolley position 72 and/or a trolley velocity 73. In some other embodiments, the trolley sensor and/or the host state sensor may include a stringpot.

Given the above discussion, here are some example circumstances that may indicate the potentially dangerous situations 40 mentioned in FIG. 5:

The spreader stack collision 50 may be implied if the spreader trajectory 122 with the container height 112 indicates that the spreader 20 will collide with the stack 24 within a predetermined time interval as shown in FIG. 1A.

The container stack collision 51 may be implied if the container trajectory 124 with the container height 112 indicate that a container 22 held by the spreader 20 will collide with the stack 24 within a predetermined time interval.

The chassis toppling condition 52 may be implied if the container trajectory 124 does not align with the chassis position 114.

A stack toppling condition 53 may be implied if the container trajectory 124 does not align with the location of the stack 24.

If the spreader 20 has been commanded to open and the spreader state 173 remains closed then the potentially dangerous situation 40 may include an indication of the spreader failure 54.

A hoist failure 56 may be indicated if the hoist 4 having been commanded to stop and the hoist position 74 continues to change and/or the hoist velocity 76 remains nonzero.

A brake failure 57 may be indicated if the brake state 177 implies there is insufficient brake fluid.

A cable failure 58 may be indicated by a sudden and unexpected change in the hoist velocity 76.

And a hydraulic failure 59 may be indicated by a hydraulic state 171 that implies there is insufficient hydraulic fluid and/or the fluid pressure is amiss.

FIG. 19 shows some examples of crane trajectory sensors 172 that may include at least one of a Global Positioning System (GPS) receiver 180, an absolute encoder 181, a Differential GPS interface 182, a position transducer 183, a radio frequency tag 184, a drawwire height/position sensor 185, a laser measurement 186, a string pot 187, and/or an ultrasonic measurement 188.

The preceding embodiments provide examples and are not meant to constrain the scope of the following claims.

What is claimed is:

1. A crane safety device, comprising: a processor configured to operate with a crane, by estimating a trajectory for a crane, determining a potentially dangerous event in response to said trajectory, and sending at least one alert message in response to said potentially dangerous event.

2. The crane safety device of claim 1, wherein said trajectory includes at least one of a container trajectory, a spreader trajectory, a hoist trajectory and a handling device trajectory.

3. The crane safety device of 1, wherein said potentially dangerous event includes at least one of a stack collision, a toppling condition, a spreader failure, a hoist failure, a cable failure and a hydraulic failure.

4. The crane safety device of claim 1, wherein said alert message includes at least one of a management system alert, an audio alarm message, a visual alarm message and an equipment shutdown message.

5. The crane safety device of claim 1, wherein said trajectory is at least partly estimated by at least one machine state of said crane.

6. The crane safety device of claim 5, wherein said crane is a gantry crane.

7. The crane safety device of claim 6, wherein said machine state includes at least one of a hoist position, a trolley position, a spreader state, a twistlock state, a cable condition, and a hoist condition.

8. The crane safety device of claim 5, wherein said crane implements at least one of a reach stacker, a side loader and a top loader.

9. The crane safety device of claim 8, wherein said machine state includes at least one of a spreader position, a spreader condition, and a hydraulic extension estimate.

10. The crane safety device of claim 5, wherein said machine state includes a location of said crane.

11. The crane safety device of claim 10, wherein said processor determines said potentially dangerous event in further response to a yard estimate.

12. The crane safety device of claim 11, wherein said yard estimate includes at least one of a container height, a truck position estimate, a chassis position estimate, a ship berth position, and a rail car position.

13. The crane safety device of claim 11, wherein said processor is configured to generate said yard estimate.

14. The crane safety device of claim 13, wherein said processor generates said yard estimate in response to at least one of a container height sensor, a container proximity sensor, a chassis alignment sensor, and a rail car position sensor.

15. The crane safety device of claim 14, further comprising a communicative coupling between said processor and at least one of said container height sensor, said container proximity sensor, said chassis alignment sensor, and said rail car position sensor.

16. The crane safety device of claim 15, wherein said communicative coupling includes at least one of a Programmable Logic Controller interface, a wireline communications interface, and a relay interface.

17. The crane safety device of claim 14, wherein a sensor group comprises at least one of said container height sensor, said container proximity sensor, said chassis alignment sensor and said rail car position sensor; and wherein at least one member of said sensor group uses at least one instance of a light emitting sensor, an ultrasonic emitting sensor and a proximity sensor.

18. The crane safety device of claim 10, wherein said location of said crane is generated by at least one of a Global Positioning System (GPS) receiver, a Differential GPS (DGPS) interface, a radio frequency tag, a laser measurement system and an ultrasonic measurement system.

19. The crane safety device of claim 1, wherein said processor includes at least one instance of at least one member of the group consisting of a finite state machine, a computer and an inference engine.

20. A method comprising the steps of:
estimating a trajectory for a crane;
determining a potentially dangerous event in response to said trajectory and a yard estimate; and
sending at least one alert message in response to said potentially dangerous event.

21. The method of claim 20, wherein the step of estimating said trajectory further comprises the step of estimating said trajectory based upon at least one machine state.

22. The method of claim 20, further comprising the step of: generating at least one yard estimate.

23. The method of claim 22, wherein said the step of generating said yard estimate is made further in response to at least one of a container height sensor, a container proximity sensor, a chassis alignment sensor, and a rail car position sensor.

24. The method of claim 23, wherein the step of generating said yard estimate includes the step of communicating across at least one instance of at least one of a Programmable Logic Controller, a wireline communications interface and a relay interface.

25. An implementation of at least part of the method of claim 20, as a member of an implementation group configured to instruct a computer and including at least one of the program steps of:
generating said at least one yard estimate;
estimating said trajectory for said crane;
determining said potentially dangerous event in response to said trajectory and said yard estimate;
sending said at least one alert message in response to said potentially dangerous event; and
creating a program system comprising at least one of the previous of said program steps;
wherein said implementation group consists of a computer readable memory, a computer accessible memory and a server.
